(19) United States
(12) Patent Application Publication
(10) Pub. No.: US 2012/0066574 A1
(43) Pub. Date: Mar. 15, 2012

(54) System, Apparatus, and Method for Inserting a Media File into an Electronic Document

(75) Inventors: LiWei Lee, New York City, NY (US); Fuzzy Khosrowshahi, Pleasantville, NY (US); Ronald Ho, Fremont, CA (US)

(73) Assignee: GOOGLE INC., Mountain View, CA (US)

(21) Appl. No.: 13/228,829

(22) Filed: Sep. 9, 2011

Related U.S. Application Data
(60) Provisional application No. 61/381,780, filed on Sep. 10, 2010.

(51) Int. Cl. G06F 17/00

(52) U.S. Cl. 715/202

(57) ABSTRACT

A formula comprising at least one parameter is received. The formula is evaluated based on the at least one parameter in the formula in order to identify the media file. The media file is accessed, and data adapted to cause the media file to be displayed in the electronic document is generated.

This application claims the benefit of the filing date of U.S. Provisional Patent Application Ser. No. 61/381,780, filed Sep. 10, 2010, which is hereby incorporated by reference herein.

### TECHNICAL FIELD

This disclosure relates generally to systems, apparatus, and methods for processing electronic document programs and applications, and more particularly to systems, apparatus, and methods for inserting a media file into an electronic document.

### BACKGROUND

Electronic documents and programs for viewing and creating electronic documents are widely-used in a variety of computing environments. For example, a spreadsheet application can be accessed by a user via a network according to a cloud computing model or from a computer local to the user (e.g. desktop computer). A spreadsheet application is a type of software that allows access to a spreadsheet in which data is arranged in table form, i.e. as rows and columns. In a typical use of a spreadsheet, data and mathematical formulas are entered in ledger-like forms for analysis, tracking, planning, or evaluations of the impacts of real or proposed changes on data.

To facilitate formulaic use of electronic documents, spreadsheet applications and similar programs may include built-in functions that perform standard calculations based on parameters input by a user (e.g. computing a sum or average of a set of numbers.) Built-in functions allow a user to input a series of parameters, which are evaluated by the program to produce a particular output. Typical examples include mathematical functions that produce numbers or text manipulation functions that generate strings of characters.

### SUMMARY

In accordance with an embodiment, a method of presenting a media file in an electronic document is provided. A formula comprising at least one parameter is received. The formula is evaluated based on the at least one parameter in the formula in order to identify the media file. The media file is accessed, and data adapted to cause the media file to be displayed in the electronic document is generated. The at least one parameter may comprise a reference to a storage location.

In accordance with an embodiment, a method of presenting a media file in an electronic document is provided. A formula comprising at least one parameter is received. The at least one parameter may comprise a search string. The formula is evaluated to generate a query that is transmitted to a search engine. In response to the query transmitted to the search engine, one or more search results are received. The search results are operable to identify one or more media files. The at least one parameter may include a parameter that identifies a media file. The media file is accessed, and data adapted to cause the media file to be displayed in the electronic document is generated.

In accordance with an embodiment, a media file may be presented in an electronic document, and there may be a search engine query that may include one or more parameters that identify a plurality of media files to be searched by the search engine. In an embodiment, the step of evaluating the formula further includes identifying a plurality of media files. In an embodiment, the method may include receiving a selection of one of the plurality of media files as the media file to be inserted. In an embodiment, the at least one parameter can include an identification of a search engine and a selection parameter.

In an embodiment, the formula may be evaluated to identify a web page. The page may include a plurality of links, each link identifying a media file and a parameter identifying one of the plurality of links. The electronic document containing the media file may be presented.

In an embodiment, generating data adapted to cause the media file to be embedded in the electronic document may include identifying a clip of the media file to be embedded in the electronic document. Examples of clips include a portion of an image, one or more scenes from a video presentation, one or more sections of an audio presentation or similar processed portions of a media file. For example, a clip of an image may include a portion, e.g. the upper left-hand quadrant, or a circle of a given radius centered at a particular position in the image. Alternatively a clip of an audio file may include the portion of the audio file that starts at a certain point in the playing of the file (e.g. one minute after the start of the audio file) and lasts for a certain duration (e.g. ninety seconds). In a media file that presents its contents in a temporally ordered fashion (e.g. an audio presentation or a video presentation) the clip may be specified by specifying the media file, specifying an offset from the beginning of the media file and specifying the duration of the clip.

In an embodiment generating data adapted to cause the media file to be embedded in the electronic document may include identifying a clip of the media file based on the at least one parameter. In an embodiment generating data adapted to cause the media file to be embedded in the electronic document may include retrieving the media file from a location, extracting a clip from the media file, and storing the clip in memory. In an embodiment, an electronic document may be configured to present a clip when the electronic document is accessed. In an embodiment, an electronic document may present a user interface input feature such as a button or a mouse-over sensor that when activated will cause an embedded clip to be presented or played.

In accordance with another embodiment, an apparatus is provided. The apparatus comprises means for providing simultaneous access to an electronic document, and means for receiving a formula from a user. The apparatus further comprises means for evaluating the formula received from the user to identify the media file. The apparatus further comprises means for presenting a media file that has been inserted into an electronic document.

These and other advantages will be apparent to those of ordinary skill in the art by reference to the following Detailed Description and the accompanying drawings.

### BRIEF DESCRIPTION OF THE DRAWINGS

FIG. 1 shows a communication system that may be used to provide online services in accordance with an embodiment;

FIG. 2 shows functional components of an exemplary user device;

FIG. 3 shows functional components of an online spreadsheet manager in accordance with an embodiment;

FIG. 4 shows a display of spreadsheet data in accordance with an embodiment;

FIG. 5 is a flowchart of a process of evaluating a formula for insertion of an image in an electronic document in accordance with an embodiment; and

FIG. 6 is a high-level block diagram of a computer which may be used to implement an embodiment.

### DETAILED DESCRIPTION

In accordance with an embodiment, a user interface is provided that enables a user to input information as a formula that can be interpreted by an application, such as a spreadsheet application. Based on the formula, the application identifies and accesses a media file, which may be an image file, for example. The media file is inserted into an electronic document, such as a spreadsheet. The media file may be presented to a user, for example, as an audio presentation, visual presentation, or a combination of audio and visual presentations.

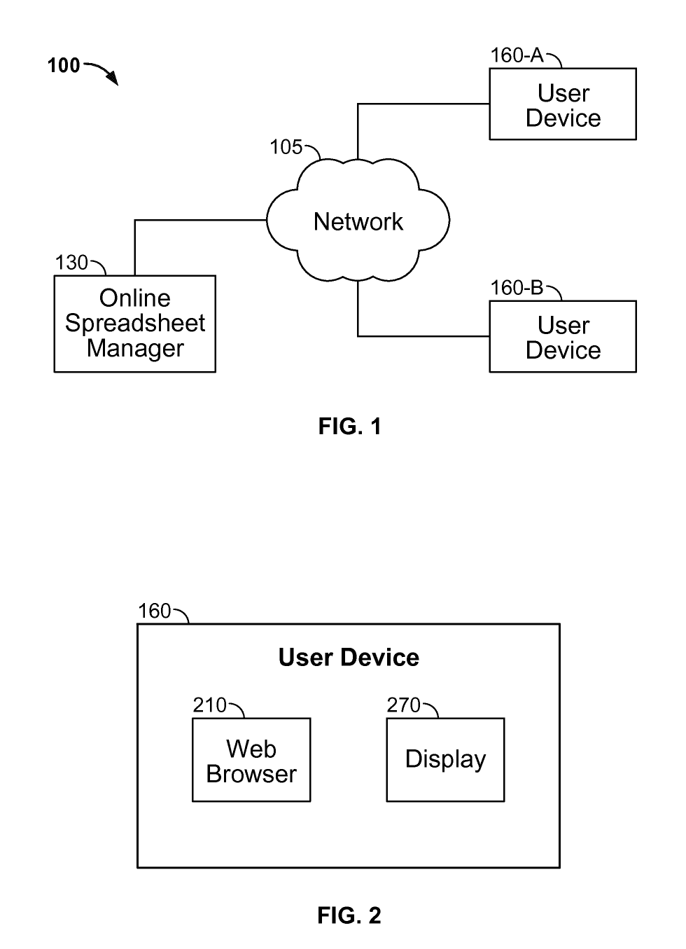

FIG. 1 shows a communication system 100 that may be used to provide online services, in accordance with an embodiment. Communication system 100 comprises a network 105, an online spreadsheet manager 130, and user devices 160-A, 160-B, etc. For convenience, the term “user device 160” is used herein to refer to any one of user devices 160-A, 160-B, etc. Accordingly, any discussion herein referring to “user device 160” is equally applicable to each of user devices 160-A, 160-B, etc. Communication system 100 may comprise more or fewer than two user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

Online spreadsheet manager 130 provides spreadsheet data management services to users via network 105, enabling users to create, display, analyze, filter, and edit one or more spreadsheet data sets remotely. Online spreadsheet manager 130 may be accessible via a World Wide Web page that may be viewed using a conventional Web browser, for example. A user may be required to log into a respective user account to access his or her spreadsheet data. Online spreadsheet manager 130 may offer common spreadsheet management features such as formatting, graphing, filtering, etc.

User device 160 may be any device that enables a user to communicate via network 105. User device 160 may be connected to network 105 through a direct (wired) link, or wireles sly. User device 160 may have a display screen (not shown) for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may also be used.

FIG. 2 shows functional components of an exemplary user device 160. User device 160 comprises a web browser 210 and a display 270. Web browser 210 may be a conventional web browser used to access World Wide Web sites via the Internet, for example. Display 270 displays spreadsheet data, documents, Web pages, and other information to a user. For example, a spreadsheet data set that a user creates or edits may be displayed on display 270.

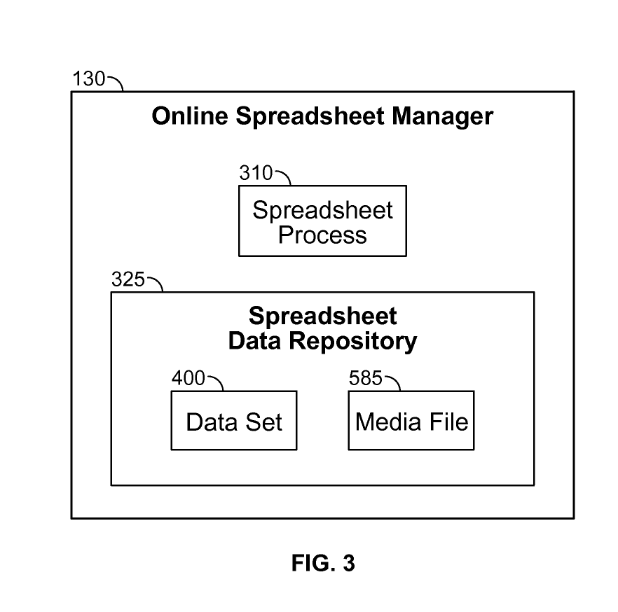

FIG. 3 shows functional components of online spreadsheet manager 130 in accordance with an embodiment. Online spreadsheet manager 130 comprises a spreadsheet process 310 and a spreadsheet data repository 325. Spreadsheet process 310 manages spreadsheet data and performs operations requested by users, such as mathematical operations, graphing, filtering, etc. One or more spreadsheet data sets created by users are stored in spreadsheet data repository 325. A spreadsheet data set created by a user may be stored in association with his or her user account, for example. Multiple versions of a user's spreadsheet data set may be stored in spreadsheet data repository 325.

In accordance with the embodiment of FIG. 1, a user may access online spreadsheet manager 130 and create and/or edit a spreadsheet data set. For example, a user may employ browser 210 to access a World Wide Web site maintained by online spreadsheet manager 130. In a well-known manner, the user may be required to log into a user account to access his or her documents. The user may be required to authenticate his or her identity, e.g., by entering a user name and password, before accessing his or her user account and spreadsheet data associated with the account.

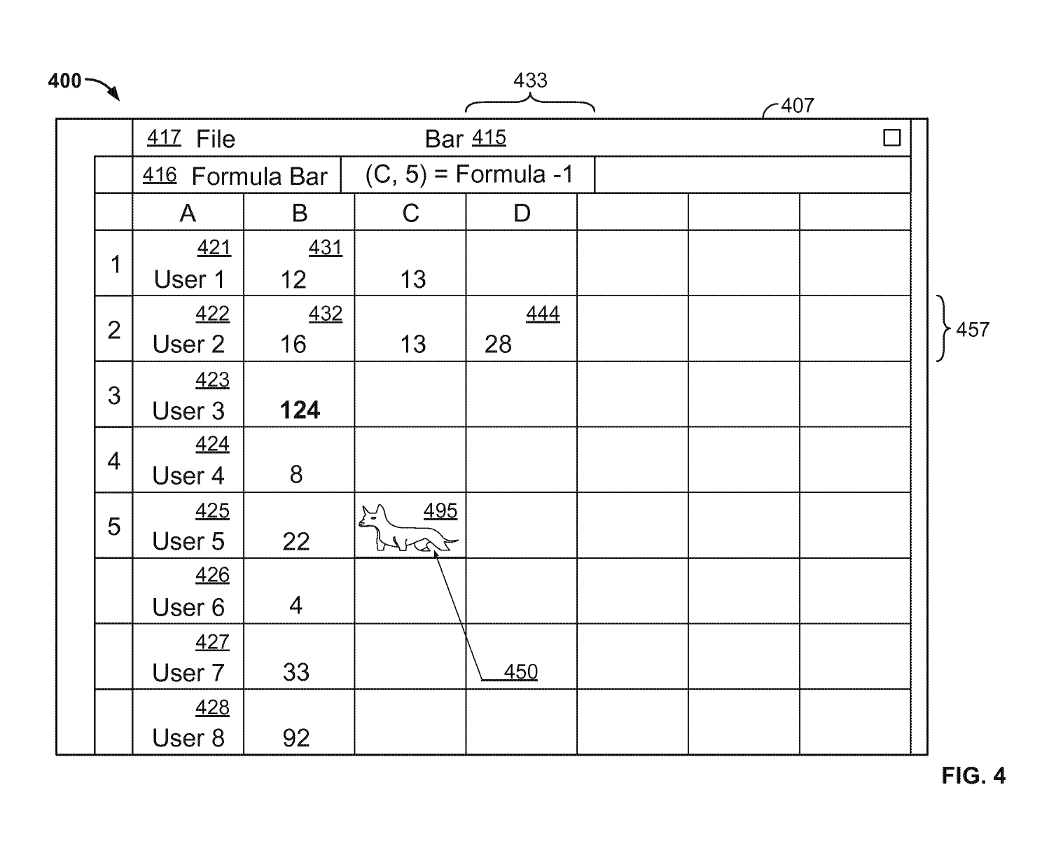

Suppose, for example, that a user employs browser 210 to access online spreadsheet manager 130 and creates a new spreadsheet data set, such as spreadsheet data set 400 illustrated in FIG. 4. Online spreadsheet manager 130 stores spreadsheet data set 400, or a representation thereof, in spreadsheet data repository 325, as shown in FIG. 3.

To enable the user to view and edit spreadsheet data set 400, online spreadsheet manager 130 transmits data causing user device 160 to display a representation of all or a portion of the spreadsheet data set 400 on a Web page, in a well-known manner. For example, online spreadsheet manager 130 may transmit to browser 210 a request, in the form of HyperText Markup Language (HTML), adapted to cause browser 210 to display a representation of spreadsheet data set 400. In response, browser 210 displays a representation of all or a portion of spreadsheet data set 400 in a window 407, as shown in FIG. 4. In a conventional manner, browser 210 displays spreadsheet data set 400 as a plurality of cells, such as cells 421, 422, 423, etc. Browser 210 also displays a toolbar 415 which may display various available options and/or functions available to the user, such as a file function 417. When the user edits and saves spreadsheet data set 400, the edited data set is stored in spreadsheet data repository 325. Browser 210 may also display a formula bar 416 into which a user may enter information for transmission to the spreadsheet manager 130.

By way of example, suppose that a user wishes to utilize a spreadsheet to record how many points various users have accumulated in a particular game. Accordingly, the user accesses online spreadsheet manager 130 and inserts information into a spreadsheet data set 400, illustrated in FIG. 4.

Referring to FIG. 4, suppose that a user enters, in rows 421-428, information identifying various users (Users 1-8), and a score associated with each respective user. For example, cell 421 which is located at the intersection of column “A” and row “1” and can be referred to as cell (A,1) identifies “User 1” and cell 431 indicates that “User1” has accumulated 12 points; cell 422 identifies “User 2” and cell 432 indicates that “User2” has accumulated 16 points, etc. Referring again to FIG. 3, online spreadsheet manager 130 stores the information in spreadsheet data set 400 in spreadsheet data repository 325.

When a document, such as a spreadsheet data set 400 is created and stored, online spreadsheet manager 130 may accept spreadsheet data that is transmitted via a network 105 from a user device 160 for insertion into a cell (e.g. cell 421) of spreadsheet data set 400. In particular, a user may also transmit a formula to online spreadsheet manager 130 by entering information into formula bar 416 on a user device 160. Formula bar 416 accepts inputs that are processed by spreadsheet process 310 and can be used to generate input to cells of the spreadsheet.

For example, in an embodiment, a formula input to formula bar 416 may specify that a number in a first cell be added to a number in a second cell. One means of specifying a particular cell in a formula is to identify the cell by referring to a row and column. For example, if a user wishes to specify a cell 444 located at the intersection of column “D” 433 and row “2” 457, he may refer to that location as, cell (D,2). For example, a user may input into the formula bar 416 a formula that specifies that the cell (D,2) is equal to the sum of the numbers in cells (B,1) and (B, 2), by entering “(D,2)=SUM((B,1)+(B,2))” in formula bar 416.

Supposing that a user enters such a formula in the formula bar 416, spreadsheet process 310 evaluates the formula and places the result into the specified cell. In the illustrative embodiment of FIG. 4, spreadsheet process 310 inserts the sum 28 into cell 444, in accordance with the formula. In an embodiment, spreadsheet process 310 can accept formulae entered into formula bar 416 that include various operators. Operators may include, for example mathematical operators such as SUMO, text manipulation operators such as CONCATENATE, or operators that specify a location from which the object of the formula can be read, such as a formula that specifies reading a value from one spreadsheet or a formula that specifies a value to be read from a network location.

Spreadsheet data set 400 may receive inputs into cells or into formula bar 416 in various forms including numbers, text, and information related to media files such as images, video or sound files. The inputs to the cells may be entered into a cell directly by a user accessing a spreadsheet from a user device 160, or via a formula entered into formula bar 416.

In accordance with an embodiment, a user may use a formula to insert a media file, such as an image, into a cell of spreadsheet 400. For example a media file insertion application may be invoked by a formula that may include a set of parameters. The set of parameters can be referred to as a “signature” of the formula. A signature may contain two parameters, the first of which specifies a media file location and the second of which specifies a scaling function to be performed on the media file as part of the presentation in the program. The number and type of parameters may be used to determine how the formula identifies the media file for inserting and displaying in the electronic document. For example, a formula including a Uniform Resource Locator (URL) and a parameter may be entered into formula bar 416, such as =FORMULA_INSERT(“URL”, scaleparameter). In this example, the URL refers to a location of a media file and the second parameter is recognized by the function FORMULA_INSERT( ) as defining an operation to be performed on that media file as part of its presentation in the cell associated with the FORMULA_INSERT( ) call.

Depending on the type of media file invoked by spreadsheet manager 130, various presentation parameters may be used. For a media file that comprises audio, presentation parameters may include, for example, volume, playback speed, playback position, or other parameters appropriate for providing audio. For a media file that comprises an image, the presentation parameter may include, for example, the size of the image, the aspect ratio, color presentation, blinking or other presentation parameters. For a media file that comprises video, presentation parameters may include playback size, volume, playback speed, playback position, or other parameters appropriate for presenting video.

In some embodiments the presentation parameters may include, parameters that indicate where in a document a media file be presented. For example, for electronic files containing media files that are presented on a display, parameters may specify the position of the media file within the electronic document, the shading, the size, or other parameters that can specify the presentation of the electronic document containing the media file.

For example, a possible set of scale parameters that may be used to determine the presentation of a media file in a spreadsheet may be the numbers: 1, 2, 3, and 4. These numbers may be used to each correspond to a particular presentation feature. In one example: “1” scales the media file to fit the cell, “2” stretches the media file to fit the cell, “3” inserts the media file into the cell in its original size, without changing the size of the cell, and “4” allows the user to specify a custom media file size. It should be noted that a scaleparameter of 4 may require the user to insert additional parameters being input into the function such as a media file height and a media file width. Alternative identifiers for various scale parameters may be used.

In some embodiments presentation parameters may be used to determine the format of the media file presented in an electronic document. Presentation parameters that may be used to determine the formatting of an electronic document include parameters that define various aspects of the presentation of a media file. In some embodiments in which a visible media file is presented, the presentation parameters may include, for example: size, shape, cropping, scale, hue, tone, opacity, transparency, color balance gamma, grey scale, stretch/scale, flip/rotate, or other parameters. In some embodiments in which an audible media file is presented, the presentation parameters may include, for example: pitch, tempo, speed, volume, key or other presentation parameters. In some embodiments in which a video media file is presented, the presentation parameters may include, for example: duration, speed, start time, end time, skip segments, or other parameters.

Suppose, in an exemplary embodiment, that the user wishes to insert an image into cell (C, 5) in spreadsheet data set 400. Accordingly, the user inputs “(C, 5)” and a formula “FORMULA-1” into formula bar 416, as shown in FIG. 4. Suppose further that FORMULA-1 is associated with a particular media file 585 stored in spreadsheet data repository 325, as shown in FIG. 3. In the illustrative embodiment, FORMULA-1 may include an address, such as a URL, associated with media file 585. Other types of parameters, and other information that may be included with a parameter, are discussed below. User device 160 transmits FORMULA-1 to spreadsheet manager 130.

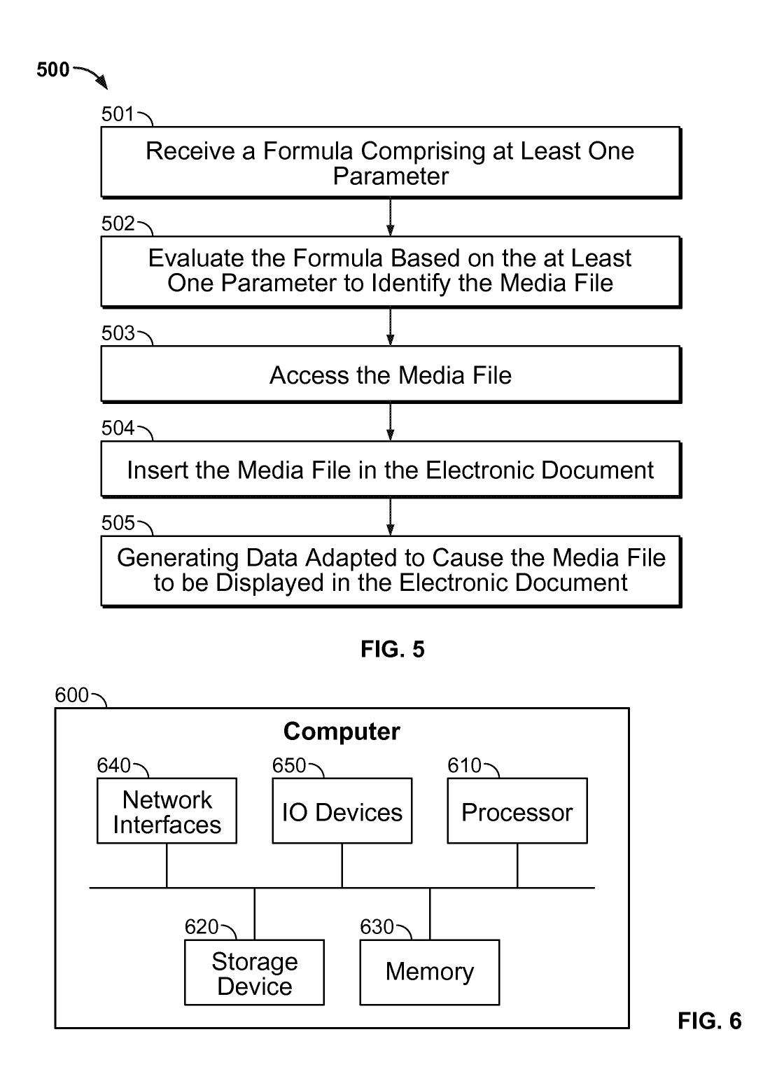

FIG. 5 is a flowchart of a method of inserting a media file into an electronic document in accordance with an embodiment. At step 501, a formula comprising at least one parameter is received. In the exemplary embodiment, spreadsheet process 310 receives FORMULA-1 from user device 160.

At step 502, the formula is evaluated based on the at least one parameter and the media file is identified. Thus, spreadsheet process 310 evaluates FORMULA-1 and identifies media file 585 based on the URL within FORMULA-1. For example, spreadsheet process 130 may examine the URL within FORMULA-1 and determine that it represents a storage location associated with the media file 585. In some embodiments, the media file may be an audio file. In some embodiments, the media file may be an image file. In some embodiments, the media file may be a video file. In accordance with some embodiments described below, a media file may be identified via an invocation of a search function.

At step 503, the media file is accessed. Thus, spreadsheet process 310 accesses media file 585 based on the URL within FORMULA-1, and retrieves media file 585. For example, spreadsheet process 310 may access the media file from storage, such as spreadsheet data repository 325, or from a remote location via a network 105.

In some embodiments, a search is initiated as a result of the evaluation of the formula. For example, spreadsheet process 310 may perform a search and, as a result, access information over network 105 to identify the media file. The search may include search parameters that can be used to identify one or more media files that suitable for presentation according to the received formula. The media file may be identified from a set of one or more files that have been returned as a result of the received formula. For example, the formula may include parameters that specify a search engine and a search string. The formula may also include parameters that can be used to determine which media file among those returned as a result of the search should be presented. For example the parameter or parameters may identify the third media file in the set of media files returned as the media file to be presented.

At step 504, the media file is inserted into the electronic document. In some embodiments, data representing the media file is inserted into the electronic document so that the media file and the electronic document are combined and the combined file is stored as a single file. In some embodiments a link or pointer to the media file is inserted into the electronic document so that the media file can be accessed when the electronic document is accessed. In some embodiments, the media file will be accessed and appear in the context of the electronic document in order to give the impression to the user that the media file and the electronic document are merged together. In an illustrative embodiment, an image associated with media file 585 is displayed in cell 495 located at location (C, 5), as shown in FIG. 4.

At step 505, data adapted to cause the media file to be displayed is generated. The data adapted to cause the media file to be generated may include presentation parameters that are evaluated in order to determine the manner in which the media file is displayed when the electronic document is accessed. For example, supposing that the media file is an image, the presentation parameters may determine the position in the electronic document at which the image is displayed. In the exemplary embodiment, image 450 is inserted into cell 495, as shown in FIG. 4.

In accordance with some embodiments, the presentation parameters may determine the orientation of an image within the electronic document or some other aspect of the presentation of the electronic document.

As discussed above, once the media file is accessed, and inserted, the presentation parameters for the media file are determined, and the media file is presented. One skilled in the art will understand that media files may be presented in various ways. For example, according to some embodiments, a media file may be presented via an application that is invoked from the electronic document in which the media file has been inserted.

In some embodiments, the media file to be inserted in the electronic document may be identified through a process that initiates a search by invoking a search engine. For example, spreadsheet process 310 may generate a search request and transmit the request to a selected search engine. The initiation of the search through the invocation of the search engine may include parameters that can be used to form the query string that is passed to the search engine. The invocation of the search engine can specify a collection of images to be searched. For example a search may be made of a photo-sharing site or a search may be made of all the sites that are contained in an index maintained by the search engine or of some other set of searchable locations. In some embodiments the initiation of the search may be made over a local disk. The search engine may be invoked using a formula using a variety of parameter signatures. The parameter signatures may include various parameters including search terms, search operators, other search parameters such as those that define a type of search or a set of documents to be searched, or a combination of several parameters. The search engine can be invoked from an input interface for the program through which the electronic document is viewed.

In some embodiments, the media file to be identified for insertion in the electronic document may be selected from a plurality of files that are returned from a search engine that has been invoked by a formula. For example, a user may input a string such as
=FORMULA_IMAGE_INSERT_SEARCH(“cute puppy”, “MyPhotoAlbum”)

In this example the search may be identified by a selection of an image from a plurality of images that are identified by the string “MyPhotoAlbum” and the search may include the query string, “cute puppy”.

In accordance with an embodiment, a search for a media file to be inserted may return a plurality of media files that meet the criterion identified in the formula. A user may be prompted to select the media file to be inserted in the electronic document from the returned media files. Alternatively, the formula may include a parameter that identifies a particular one or more of the returned media files for insertion in the electronic document.

In an embodiment, a set of media files to be searched may be protected so that the files can only be accessed after authentication such as supplying credentials, for example a username-password combination. A user who is not authenticated cannot access the set of media files, and may receive a response indicating that the formula was unable to perform the search.

In an embodiment, the FORMULA_INSERT( ) function may accept a parameter signature that defines a location and a parameter that is used by the FORMULA_INSERT( ) function in selecting a specific media file from that location. For example, the location could be the front page of a news web site and the parameter would be used by the function to return the largest media file appearing on the news web site at the time that the function is invoked. Another guidance parameter may define the fifth media file down the page or the media file in the upper right-hand corner of the web page. Another parameter might be used to identify the FORMULA_INSERT( ) function to return the most important media file on a web page or in a corpus. For example the importance of the media file can be determined by a default setting for the function or customized according to a user's input.

In some embodiments in which the media file is inserted into the electronic document, an API is accessed so that the media file from a program that manipulates files of the type in which the media file is inserted. For example, if the media file is an image and the electronic document is an encoded document, the media file may be inserted into the electronic document through the functionality provided by an API. In some embodiments, where the step of inserting the media file into the electronic document is performed by inserting a link into the electronic document, a link may be entered in the electronic document. For example, in an example where the electronic document is a plain text document such as an XML document, a string corresponding to a link to the media file may be inserted in the electronic document.

In an embodiment, a formula can be invoked with parameters that specify that the media file may be of various types. For example, the media file may be a video file, or another media file rather than a media file. Different types of media file may have associated parameters that can change the presentation of that type of media file.

In an embodiment, a video file may be inserted into a position in an electronic document associated with location (C, 5) by using an invocation of a function such as the following:
(C, 5) =FORMULA_INSERT(video, “URL to video”,
Audio_or_video_only, loop_after playing, play_speed, play_begin,
play_end, video_height, video_width, play_on_load or play_on_hover).

In this example there are several parameters that may be accepted by the FORMULA_INSERT( ) function and used to determine the manner in which the video is presented in the electronic document. Examples of some of the parameters that might be included as part of controlling the presentation of the video include:
URL to video—Inserts a video located at a particular URL into the electronic document.
Audio only—Inserts a media file comprising a video but only provides the video without the accompanying audio from that media file.
Video_only—Inserts a media file comprising a video but only provides the audio without the accompanying video from that media file.
Loop_after playing—Inserts a media file and loops the file after it finishes playing.
Play_speed—Inserts a media file and presents the file at a specific play speed.
Play_begin—Inserts a media file and presents the file starting at a specific point within the file.
Play_end—Inserts a media file and presents the file up until a specific point in the media file.
Video_presentation parameters—Inserts a media file and presents it with a specified width, height, aspect ratio or other formatting parameter.
Play_on_load—Inserts a media file and begins to play it as soon as the electronic document into which the file is inserted is loaded into memory.
Play_on_hover—Inserts a media file and begins to play it as soon as the interface detects that the user is hovering over the media file with his pointing device.

The FORMULA_INSERT( ) functions may be called with other parameters or with combinations of these and other parameters in order to optimize response for a particular application.

In some embodiments, the formula may refer to multiple cells. For examples, spreadsheet process 310 may evaluate a formula and identify media files to be inserted into a plurality of cells. In some embodiments, a different media file may be identified for each of a plurality of cells based on the formula. Therefore, in some embodiments, the spreadsheet process 310 evaluates the formula to determine different parameters to use in presenting media files in each of a plurality of cells.

In various embodiments, the method steps described herein, including the method steps described in FIGS. 5 may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to present specified data on a screen, etc. For example, the server may transmit a request adapted to cause a client computer to perform one or more of the method steps described herein, including one or more of the steps of FIG. 5. Certain steps of the methods described herein, including one or more of the steps of FIG. 5 may be performed by a server or by another processor in a network-based cloud-computing system. Certain steps of the methods described herein, including one or more of the steps of FIG. 5 may be performed by a client computer in a network-based cloud computing system. The steps of the methods described herein, including one or more of the steps of FIG. 5 may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5 may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus, and methods described herein is illustrated in FIG. 6. Computer 600 comprises a processor 610 operatively coupled to a data storage device 620 and a memory 630. Processor 610 controls the overall operation of computer 600 by executing computer program instructions that define such operations. The computer program instructions may be stored in data storage device 620, or other computer readable medium, and loaded into memory 630 when execution of the computer program instructions is desired. Thus, the method steps of FIG. 5 can be defined by the computer program instructions stored in memory 630 and/or data storage device 620 and controlled by processor 610 executing the computer program instructions. For example, the computer program instructions can be implemented as computer executable code programmed by one skilled in the art to perform an algorithm defined by the method steps of FIG. 5. Accordingly, by executing the computer program instructions, the processor 610 executes an algorithm defined by the method steps of FIG. 5. Computer 600 also includes one or more network interfaces 640 for communicating with other devices via a network. Computer 600 also includes one or more input/output devices 650 that enable user interaction with computer 600 (e.g., present, keyboard, mouse, speakers, buttons, etc.).

Processor 610 may include both general and special purpose microprocessors, and may be the sole processor or one of multiple processors of computer 600. Processor 610 may comprise one or more central processing units (CPUs), for example. Processor 610, data storage device 620, and/or memory 630 may include, be supplemented by, or incorporated in, one or more application-specific integrated circuits (ASICs) and/or one or more field programmable gate arrays (FPGAs).

Data storage device 620 and memory 630 each comprise a tangible non-transitory computer readable storage medium. Data storage device 620, and memory 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 650 may include peripherals, such as a printer, scanner, present screen, etc. For example, input/output devices 650 may include a present device such as a cathode ray tube (CRT) or liquid crystal present (LCD) monitor for presenting information to the user, a keyboard, and a pointing device such as a mouse or a trackball by which the user can provide input to computer 600.

One skilled in the art will recognize that an implementation of an actual computer or computer system may have other structures and may contain other components as well, and that FIG. 6 is a high level representation of some of the components of such a computer for illustrative purposes.

Some of the embodiments described herein specify particular types of media files such as image files or video files. Furthermore, some of the embodiments describe specific types of electronic documents such as spreadsheets. However, the scope of the invention is not limited in terms of the types of media files or electronic documents that may be used.

In particular, methods and systems described herein may be used with various types of media files such as: image files, text files, portable document files, presentation files, video files, audio files, or other files. Furthermore, various types of electronic documents such as: spreadsheet documents, presentation documents, text documents, database documents, drawing documents, design documents, or other electronic document types.

The foregoing Detailed Description is to be understood as being in every respect illustrative and exemplary, but not restrictive, and the scope disclosed herein is not to be determined from the Detailed Description, but rather from the claims as interpreted according to the full breadth permitted by the patent laws. It is to be understood that the embodiments shown and described herein are only illustrative of the principles and that various modifications may be implemented by those skilled in the art without departing from the scope and spirit of the present disclosure. Those skilled in the art could implement various other feature combinations without departing from the scope and spirit of the present disclosure. The various functional modules that are shown are for illustrative purposes only, and may be combined, rearranged and/or otherwise modified.

1. A method of presenting a media file in an electronic document, comprising:
receiving a formula, the formula comprising at least one parameter;
evaluating the formula based on the at least one parameter to identify the media file;
accessing the media file;
generating data adapted to cause the media file to be embedded in the electronic document;
embedding the media file in the electronic document; and
presenting the media file.

2. The method of claim 1, wherein evaluating the formula comprises determining a location of at least one media file and determining an embedding parameter for the media file.

3. The method of claim 2, wherein generating data adapted to cause the media file to be embedded in the electronic document comprises:
identifying a clip of the media file based on the at least one parameter; and
extracting the clip from the media file.

4. The method of claim 3, wherein the media file comprises a temporally ordered presentation and the clip is offset from the beginning of the presentation.

5. The method of claim 4, wherein embedding the media file in the electronic document comprises:
configuring the electronic document to present the clip when the section of the electronic document is accessed, independent of the at least one media file.

6. The method of claim 1 wherein the formula comprises a search string, and evaluating the formula to identify the media file further comprises:
transmitting a request to a search engine.

7. The method of claim 6, wherein evaluating the formula further comprises:
identifying a plurality of media files.

8. The method of claim 7, further comprising:
receiving a selection of one of the plurality of media files as the media file.

9. The method of claim 8, wherein the at least one parameter comprises an identification of a search engine and a selection parameter.

10. The method of claim 5, wherein evaluating the formula further comprises:
identifying a web page comprising a plurality of links, each link identifying a media file, the at least one parameter identifying one of the plurality of links.

11. A non-transitory computer readable medium having program instructions stored thereon, the instructions capable of execution by a processor and defining the steps of:
receiving a formula, the formula comprising at least one parameter;
evaluating the formula based on the at least one parameter to identify a media file;
accessing the media file, based on the formula;
generating data that causes the media file to be embedded in the electronic document;
embedding the media file and the parameter in the electronic document; and
presenting the media file.

12. The non-transitory computer medium of claim 11, wherein evaluating the formula comprises determining a location of at least one media file and determining an embedding parameter for the media file.

13. The non-transitory computer medium of claim 12, wherein generating data adapted to cause the media file to be embedded in the electronic document comprises:
identifying a clip of the media file based on the at least one parameter; and
extracting the clip from the media file.

14. The non-transitory computer medium of claim 13, wherein the media file comprises a temporally ordered presentation and the clip is offset from the beginning of the presentation.

15. The non-transitory computer medium of claim 14, wherein embedding the media file in the electronic document comprises:
configuring the electronic document to present the clip when the section of the electronic document is accessed, independent of the at least one media file.

16. The non-transitory computer medium of claim 11 wherein the formula comprises a search string, and evaluating the formula to identify the media file further comprising:
transmitting a request to a search engine.

17. The non-transitory computer medium of claim 16, wherein evaluating the formula further comprises:
identifying a plurality of media files.

18. The non-transitory computer medium of claim 17, further comprising instructions defining the step of:
receiving a selection of one of the plurality of media files as the media file.

19. The non-transitory computer medium of claim 18, wherein the at least one parameter comprises an identification of a search engine and a selection parameter.

20. The non-transitory computer medium of claim 15, wherein evaluating the formula further comprises:
identifying a web page comprising a plurality of links, each link identifying a media file, the at least one parameter identifying one of the plurality of links.
